(19) United States
(12) Patent Application Publication
(10) Pub. No.: US 2019/0065446 A1
(43) Pub. Date: Feb. 28, 2019

(54) REDUCING TEXT LENGTH WHILE PRESERVING MEANING

(71) Applicant: Microsoft Technology Licensing, LLC, Redmond, WA (US)

(72) Inventor: Gergely Z. Kota, Kirkland, WA (US)

(21) Appl. No.: 15/682,899

(22) Filed: Aug. 22, 2017

(51) Int. Cl. G06F 17/22; G06F 17/21; G06F 17/27

(52) U.S. Cl. CPC G06F 17/2264; G06F 17/274; G06F 17/2705; G06F 17/211

(57) ABSTRACT

Methods and systems for reducing text length. One system includes an electronic processor configured to receive text having an original length, automatically divide the text into a plurality of terms, and automatically select a set of transformations for the text based on at least one rule. The processor is further configured to automatically, serially apply each transformation included in the set of transformations to each of the plurality of terms satisfying a condition associated with each transformation to generate an alternate version of the text having an alternate length less than the original length while the alternate length is greater than a desired length. In response to the alternate length being equal to or less than the desired length, the processor is configured to output the alternate version of the text having the alternate length being equal to or less than the desired length for display within a user interface.

### FIELD

Embodiments described herein relate to reducing text length, such as text displayed within a space-constrained area of a user interface, without sacrificing context or meaning.

### SUMMARY

Software applications commonly display text to users through one or more user interfaces. A user interface, however, may be space-constrained such that there is limited space to display text. For example, some software applications display text within cells or grids to present text in an ordered manner. Similarly, software applications generating presentations, such as PowerPoint® provided by Microsoft Corporation, may have limited areas to display text. When text to be displayed within such a space-constrained area does not fit, the size or font of the text may be changed. However, changing the size or font of the text may impact the readability of the text. Alternatively or in addition, the text may be truncated, or the user interface may require that the user scroll through or expand the user interface to view the entire text. Accordingly, in these situations, the text displayed to the user is incomplete or difficult to understand, which creates inefficiencies and may lead to human errors.

Thus, embodiments described herein provide, among other things, systems and methods for reducing a length of text. In particular, the methods and systems modify text to be equal to or less than a desired length (in number of characters) while retaining as much semantic meaning as possible. The methods and systems may apply a configurable set of transformations until the desired length of text is achieved. As compared to merely truncating text to achieve a desired length, the configurable set of transformations may replace one or more terms included in the text with alternate text having fewer characters to reduce a length while preserving semantic meaning. In some embodiments, the configurable set of transformations is applied in a predetermined order where less aggressive transformations are applied before more aggressive transformations. In other words, transformations that replace original text with alternate text that closely matches the original text are applied before transformations that replace original text with alternate text that differs more drastically from the original text. For example, transformations that replace phrases with contractions may be applied before transformations that replace terms with emoticons or abbreviations and truncation is only performed as a final option when all of the transformations have been applied. Accordingly, in this manner, as much semantic meaning can be preserved as possible. Furthermore, the set of transformations and the order of transformation can be automatically selected based on one or more rules to further intelligently apply transformations to retain as much semantic meaning as possible.

For example, one embodiment provides a system for reducing a length of text. The system includes an electronic processor. The electronic processor is configured to receive text having an original length, receive a desired length for the text, and automatically divide the text into a plurality of terms by generating a hierarchy of terms based on the text. The electronic processor is also configured to automatically select from a plurality of available transformations a set of transformations for the text based on at least one rule. The at least one rule is associated with at least one selected from a group consisting of an identifier of a user, the text, the hierarchy of terms, the original length, the desired length, and a software application outputting the text. In addition, the electronic processor is configured to automatically, serially apply each transformation included in the set of transformations to each of the plurality of terms included in the hierarchy of terms satisfying a condition associated with each transformation to generate an alternate version of the text having an alternate length less than the original length while the alternate length is greater than the desired length. In response to the alternate length being equal to or less than the desired length, the electronic processor is configured to output the alternate version of the text having the alternate length being equal to or less than the desired length for display within a user interface. In response to the alternate length being greater than the desired length after application of each of the transformation included in the set of transformations, the electronic processor is configured to output a version of the text truncated to the desired length for display within the user interface.

Another embodiment provides a method for reducing a length of text. The method includes receiving, with an electronic processor, text having an original length and a desired length for the text. The method also includes automatically, with the electronic processor, dividing the text into a plurality of terms by generating a hierarchy of terms based on the text using at least one grammar parser and automatically selecting from a plurality of available transformations a set of transformations for the text based on at least one rule. The at least one rule is associated with at least one selected from a group consisting of an identifier of a user, the text, the hierarchy of terms, the original length, the desired length, and a software application outputting the text. The method further includes automatically, with the electronic processor, serially applying each transformation included in the set of transformations to each of the plurality of terms included in the hierarchy of terms satisfying a condition associated with each transformation to generate an alternate version of the text having an alternate length less than the original length while the alternate length is greater than the desired length. The method also includes, in response to the alternate length being equal to or less than the desired length, outputting, with the electronic processor, the alternate version of the text having the alternate length being equal to or less than the desired length for display within a user interface. The method further includes, in response to the alternate length being greater than the desired length after application of each of the transformation included in the set of transformations, outputting, with the electronic processor, a version of the text truncated to the desired length for display within the user interface.

Yet another embodiment provides a non-transitory computer-readable medium including instructions executable by an electronic processor to perform a set of functions. The set of functions includes receiving text having an original length, receiving a desired length for the text, and automatically dividing the text into a plurality of terms. The set of functions further includes automatically selecting from a plurality of available transformations a set of transformations and an order of the set of transformations for the text based on at least one rule. The at least one rule being associated with at least one selected from a group consisting of an identifier of a user, the text, the hierarchy of terms, the original length, the desired length, and a software application outputting the text. The set of functions also includes automatically serially applying each transformation included in the set of transformations to each of the plurality of terms included in the hierarchy of terms satisfying a condition associated with each transformation to generate an alternate version of the text having an alternate length less than the original length while the alternate length is greater than the desired length. Furthermore, the set of functions includes, in response to the alternate length being equal to or less than the desired length, outputting the alternate version of the text having the alternate length being equal to or less than the desired length for display within a user interface. The set of functions also includes, in response to the alternate length being greater than the desired length after application of each of the transformation included in the set of transformations, outputting a version of the text truncated to the desired length for display within the user interface.

### BRIEF DESCRIPTION OF THE DRAWINGS

FIG. 1 illustrates a user interface including text displayed within a space-constrained area.

FIG. 2 schematically illustrates a system for outputting text according to one embodiment.

FIG. 3 is a flowchart illustrating a method for reducing a length of text performed by the system of FIG. 2 according to one embodiment.

FIG. 4 illustrates one example of a set of transformations selected as part of the method of FIG. 3 according to one embodiment.

FIG. 5 illustrates one example of applying a set of transformations to text as part of the method of FIG. 3 according to one embodiment.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

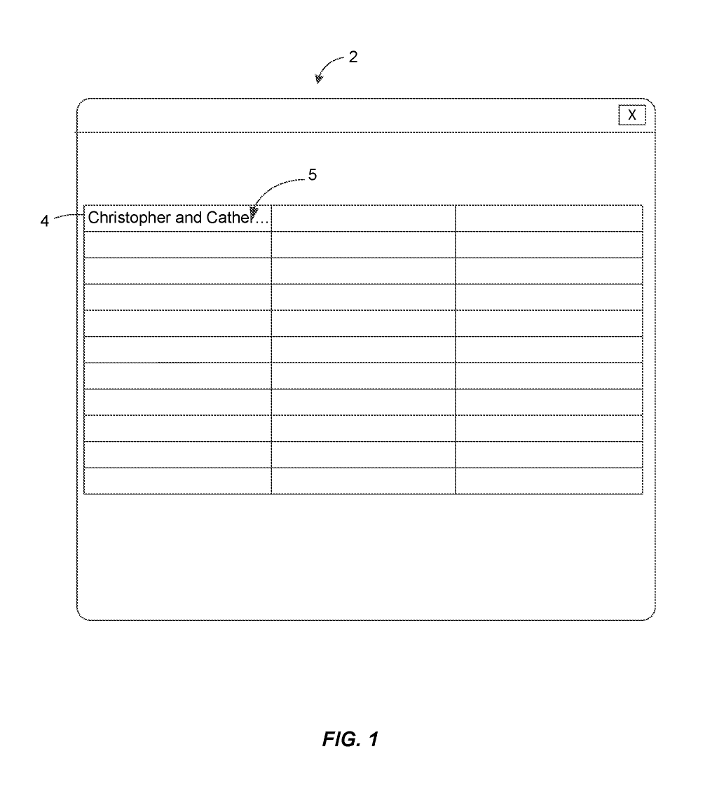

As described above, text displayed within a user interface may not fit within the user interface, which impacts a user's ability to read and understand the text. For example, as illustrated in FIG. 1, a user interface 2 includes an area 4, such as a spreadsheet cell, that displays text 5. The area 4 may be space-constrained such that the size of the area 4 cannot be changed (for example, because the area 4 is at a maximum size, because changing the size would impact the formatting of the user interface 2, or a combination thereof). Thus, as illustrated in FIG. 1, the text 5 displayed in the area 4 may be truncated because the length of the text exceeds the size of the area 4. For example, assume the text 5 is “Christopher and Catherine went to the Department of Motor Vehicles.” In this situation, as illustrated in FIG. 1, only a truncated portion of the text 5 (“Christopher and Cather . . . ”) is displayed in the area 4.

Accordingly, to address these and other technical problems associated with outputting text within a space-constrained area, systems and methods described herein reduce a length of text to fit within such a space-constrained area while preserving context and meaning. In particular and as described in further detail below, rather than merely truncating text to fit within the area, the systems and methods apply one or more transformation to reduce the length of text without sacrificing semantic meaning.

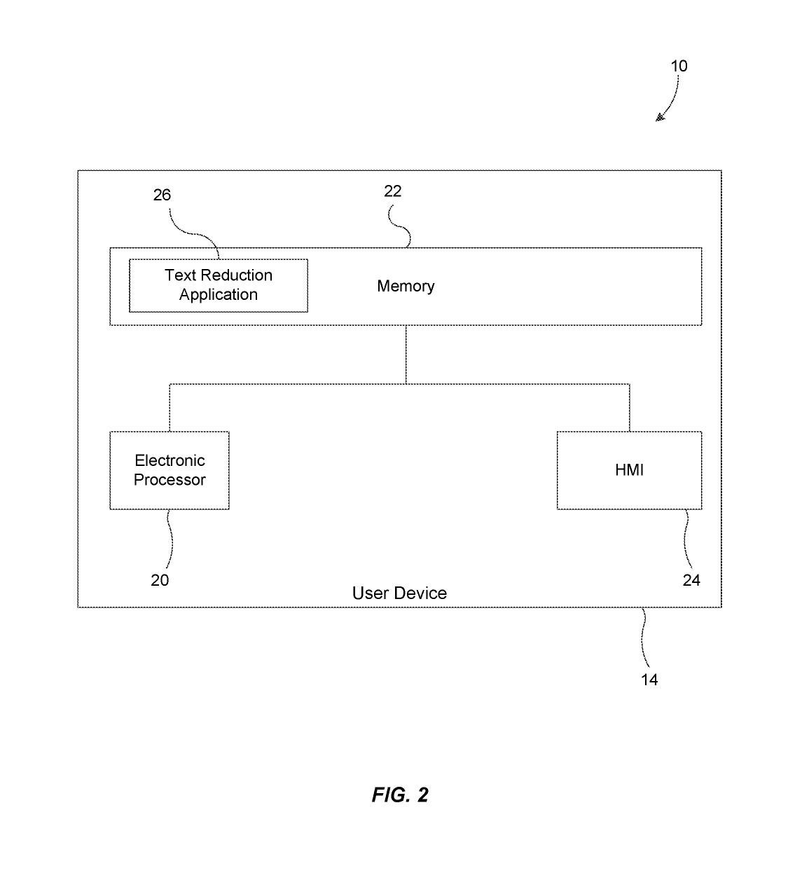

For example, FIG. 2 schematically illustrates a system 10 for outputting text. As illustrated in FIG. 2, the system 10 includes a user device 14. It should be understood that the system 10 is provided as an example and, in some embodiments, the system 10 includes additional components. For example, the system 10 may include more than one user device 14, a server, a communication network, and the like. For example, the functionality performed by the system 10 is described herein as being performed locally at the user device 14 where text is output to one or more users. However, in other embodiments, the functionality or a portion thereof may be performed remote from the user device 14. For example, a server (such as a server included in a cloud service) may be configured to reduce a length of text output through the user device 14. Accordingly, in this situation, the user device 14 may communicate (directly or via one or more intermediary devices) with one or more servers over one or more communication networks (for example, a wide area network, such as the Internet, a local area network, such as a Bluetooth™ network or Wi-Fi, or the like), over one or more dedicated (wired or wireless) connections, or a combination thereof to receive length-reduced text and, in some embodiments, to provide original text needing length-reduction.

In one embodiment, the user device 14 is a personal computing device, such as a desktop computer, a laptop computer, a terminal, a smart television, an electronic whiteboard, a tablet computer, a smart telephone, a wearable device, or the like. As illustrated in FIG. 2, the user device 14 includes an electronic processor 20, a memory 22, and a human-machine interface (HMI) 24. The electronic processor 20, the memory 22, and the HMI 24 communicate over one or more communication lines or buses, wirelessly, or a combination thereof. In some embodiments, the user device 14 includes additional components than those illustrated in FIG. 2 and the components included in the user device 14 may arranged in various configurations. For example, in some embodiments, the user device 14 also includes a communication interface, such as a transceiver, that allows the user device 14 to communicate with external devices, such as one or more server over a communication network as noted above. The user device 14 may also perform additional functionality than the functionality described in the present application.

The electronic processor 20 may include a microprocessor, application-specific integrated circuit (ASIC), or another suitable electronic device. The electronic processor 20 is configured to retrieve data from the memory 22 and execute, among other things, software related to the processes and methods described herein. The memory 22 includes a non-transitory, computer-readable storage medium.

The HMI 24 includes an input device, an output device, or a combination thereof. For example, the HMI 24 may include a display device, a touchscreen, a keyboard, a keypad, a button, a cursor-control device, a printer, a speaker, a virtual reality headset, a microphone, and the like. In some embodiments, the user device 14 includes multiple HMIs. For example, the user device 14 may include a touchscreen and a keypad. In some embodiments, a HMI 24 is included in the same housing as the user device 14. However, in other embodiments, a HMI 24 may be external to the user device 14 but may communicate with the user device 14 over a wired or wireless connection. For example, in some embodiments, the user device 14 includes a display device connected to the user device 14 via a cable. As described below in more detail, one or more HMIs 24 included in the user device 14 may receive text from a user and may output an alternate version of the received text with a reduced length.

For example, as illustrated in FIG. 2, the user device 14 includes a text reduction application 26 stored in the memory 22 in a format that is executable by the electronic processor 20. The text reduction application 26 (when executed by the electronic processor 20) receives text and generates an alternate version of the received text that has a shorter length than the received text by removing characters, shortening phrases to contractions, replacing words with acronyms, and the like. In some embodiments, the functionality described herein as being performed by the text reduction application 26 is distributed between multiple applications executed by the electronic processor 20. For example, in some embodiments, the functionality described herein relating to certain aspects of text length reduction (such as specific transformations) may be provided through a separate transform application that interacts with (as a plug-in) the text reduction application 26.

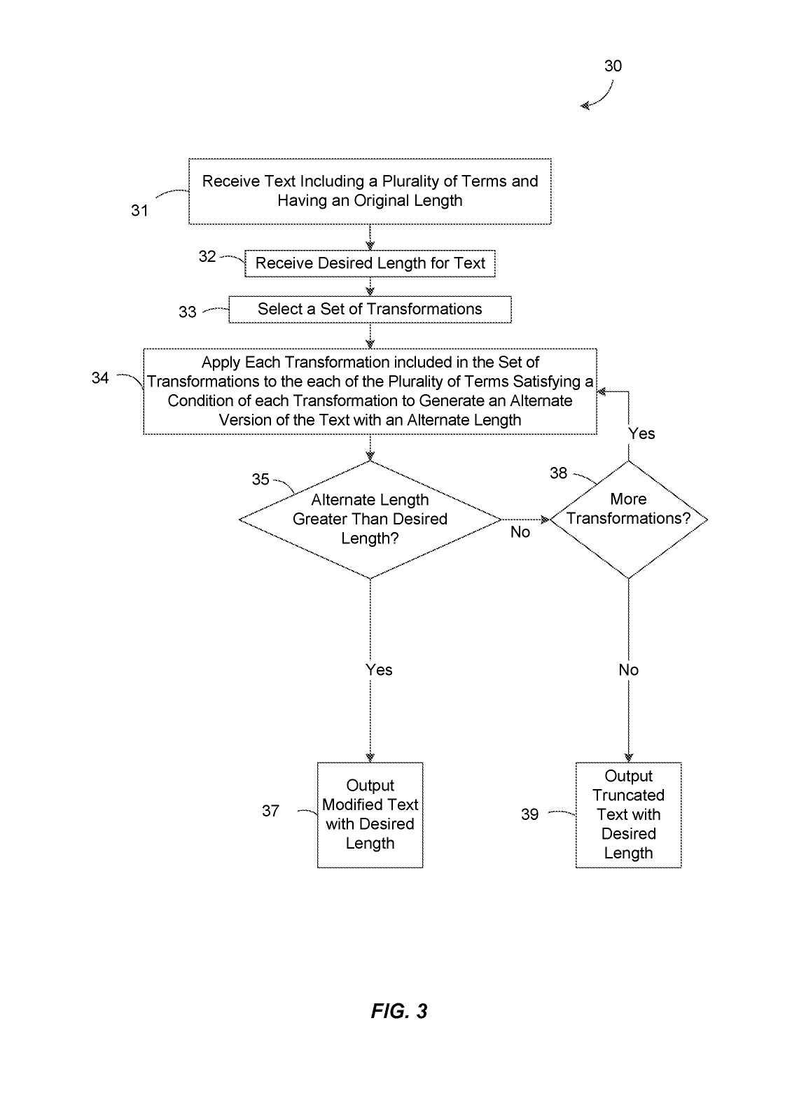

FIG. 3 illustrates a method 30 of reducing a length of text performed by the system 10. The method 30 is described herein as being performed by the electronic processor 20 of the user device 14 through execution of the text reduction application 26. However, as noted above, in some embodiments, the method 30 (or a portion thereof) may be performed by one or more other devices, such as one or more servers accessible through a cloud service.

As illustrated in FIG. 3, the method 30 includes receiving, with the electronic processor 20, text with an original length (at block 31). The electronic processor 20 may receive the text from a user through an HMI 24, such as a touchscreen, a microphone (audio data translated into text), a keypad, or the like. Alternatively or in addition, the electronic processor 20 may receive the text from the memory 22 or from a memory included an external device, such as a server that communicates with the user device 14 over a communication network.

The text may include alphabetic characters, numerals, spaces, symbols, emoticons, punctuation, and the like. The original length of the text may be a number of characters or a length measurement (such as inches, millimeters, and the like). As used in the present application, a number of characters may include all parts of received text including alphabetic characters, numerals, icons, emotions, punctuation, spaces, and the like. The electronic processor 20 may receive a length of the text with the text as separate user input, as metadata associated with the text, or the like. Alternatively or in addition, the electronic processor 20 may determine the length of the received text, such as by counting a number of characters included in the text.

As illustrated in FIG. 3, the method 30 also includes receiving, with the electronic processor 20, a desired length for the received text (at block 32). The electronic processor 20 may receive the desired length from a user through a HMI 24. For example, a user may provide via a HMI 24 both the original text and a desired length for the text. Alternatively or in addition, the electronic processor 20 may determine the desired length for the text based on an area where the text will be displayed within a user interface. For example, when the text is to be displayed within a particular cell or field of an electronic document, the electronic processor 20 may determine a length of text that fits within the cell or field, such as based on the width, height, or both of the cell or field and the size and font of the text. In other embodiments, the electronic processor 20 may use a predetermined default length as the desired length. Again, the desired length may be specified as a number of characters or a length measurement, such as a length in inches, centimeters, or the like.

The received text includes a plurality of terms. For example, in one embodiment, the electronic processor 20 is configured to divide the received text into a plurality of terms. A term may be a paragraph, a sentence, a word, one or more letters, or the like. Accordingly, as used in the present application, a term may be any portion of the received text. As one example, assume the received text is “Christopher does not have an appointment.” In this situation, the electronic processor 20 may divide the text into discrete paragraphs, sentences, and words. In particular, the electronic processor 20 may divide this example text into one paragraph, one sentence, and six words, and may store a hierarchy of this division in the memory 22, such as the following example hierarchy.

```
Paragraph {
      Sentence {
            Word: “Christopher”,
            Word: “does”,
            Word: “not”,
            Word: “have”,
            Word: “an”,
            Word: “appointment”
      },
      Punctuation: “.”
}
```

The electronic processor 20 may use one or more grammar parsers to divide text into a plurality of terms. The grammar parsers may use punctuation, sentence structures, stored grammar rules, and the like to divide text into terms. In some embodiments, the electronic processor 20 uses a grammar parser unique to the language of the text. For example, when the text is in English, the electronic processor 20 may use a parser unique to the English language to divide the text into terms. Similarly, when the text is in Spanish, the electronic processor 20 may use a parser unique to the Spanish language to divide the text into terms. In some embodiments, rather than dividing the text into terms, the electronic processor 20 may receive text already divided into terms. For example, the electronic processor 20 may initially receive the text as a plurality of terms or may receive both the text and a separate hierarchy of terms.

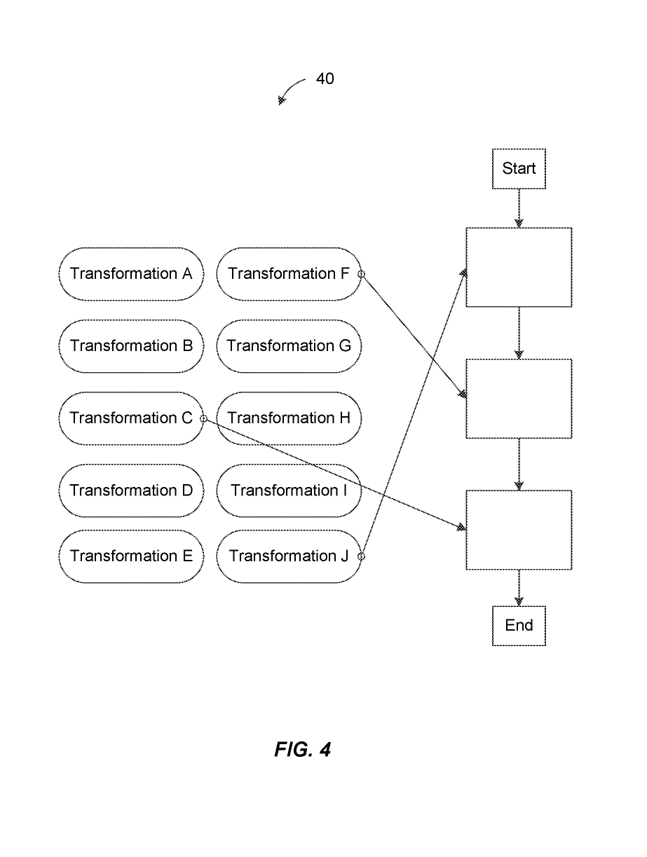

As illustrated in FIG. 3, the method 30 further includes selecting a set of transformations for the text (at block 33). For example, as illustrated in FIG. 4, the text reduction application 26 may be configured to apply one or more transformations from a set of available transformations 40 (Transformations A, B, C, D, E, F, G, H, I, and J) to reduce a length of text. In some embodiments, any number of the transformations may be applied in any order or combination. For example, as illustrated in FIG. 4, as one example, only Transformations C, F, and J are applied and Transformation J is applied first, Transformation F is applied second, and Transformation C is applied last.

The electronic processor 20 may select the set of transformations based on a user-selected configuration. For example, in some embodiments, the electronic processor 20 may be configured to display a list of available transformations and receive user input selecting a set of transformations from the list. The set may include one or all of the available transformations. In some embodiments, a user may similarly be able to select an order of transformations within the set of transformations. As described in more detail below, the order specified by the user may be used by the electronic processor 20 to serially apply transformations until the length of the text is reduced to the desired length.

In some embodiments, a user may configure a set of transformations (and an order of transformations) for different types of text or other conditions. For example, when text includes numerals, the user may specify a first set (and order) of transformations and when text includes alphabetic characters, the user may specify a second set of transformations. Similarly, a user may configure a first set (and order) of transformations for text provided through a first type of application, such as word processing application and may configure a second set (and order) of transformations for text provided through a second type of application, such as a spreadsheet, database, or presentation application. Thus, in these situations, the electronic processor 20 may be configured to select an applicable set of transformations from multiple configurations previously set by a user. Accordingly, a user may select a set of transformations for individual text or may establish one or more default sets of transformations to be applied to text.

Similarly, in some embodiments, the electronic processor 20 may be configured to apply one or more rules to automatically select a set of transformations, or order of transformation, or a combination thereof for received text. The rules may be based on the text or a portion thereof (one or more characters included in the text), an identifier of a user (identifying an individual user or a user role) requesting the reduction, the software application outputting the text, the original length of the text, the desired length of the text, the hierarchy of terms, or a combination thereof. Accordingly, rather than having a user configure a set (and order) of transformations, the electronic processor 20 may be configured to automatically select (and order) transformations. For example, depending on a difference between the original length and the desired length, the electronic processor 20 may be configured to automatically select more aggressive transformations or less aggressive transformations. In general, the more aggressive the transformation, the more the transformed text differs (in length, substance, or both) from the original text. For example, a transformation that replaces the phrase “can not” with “can't” as described below may be considered less aggressive that a transformation that replaces the phrase “can not” with “not” or a transformation that replaces the phrase “can not” with an icon “0”. Similarly, when the text includes many numbers as compared to alphabetic characters, the electronic processor may be configured to automatically select transformations applicable to transforming numbers. As noted above, the electronic processor 20 may be configured to automatically select an order for selected transformations using similar rules. For example, in some embodiments, the electronic processor 20 orders the transformations from less aggressive to more aggressive such that less aggressive transformations are applied before more aggressive transformations. Accordingly, in this manner, as much semantic meaning can be preserved as possible. In some embodiments, the electronic processor 20 may be configured to display selected transformations (and orders of such transformations) to a user for approval or modification as necessary.

The transformations available through the text reduction application 26 can reduce text length in various ways (other than there mere truncation that fails to preserve semantic meaning) and some non-limiting examples are provided herein. For example, the available transformations may include a transformation that creates contractions from one or more of the plurality of terms (a contraction transformation). As an example, when the received text is “Christopher does not have an appointment.” as provided above, the electronic processor 20 may apply the contraction transformation to replace the terms “does” and “not” with the term “doesn't”. The electronic processor 20 may use a look-up table, rules, or a database to find and replace terms with appropriate contractions.

The available transformations may also include a transformation that creates acronyms from one or more of the plurality of terms (an acronym transformation). For example, when the received text is “The United States of America has a Department of Defense.”, the electronic processor 20 may apply the acronym transformation to replace the term “United States of America” with the acronym “USA” and replace the term “Department of Defense” with the acronym “DoD”. The electronic processor 20 may use a look-up table, rules, or a database to find and replace terms with appropriate acronyms. For example, the electronic processor 20 may automatically generate acronyms by identifying proper nouns or titles and replacing such terms with an appropriate acronym. For example, when received text includes the term “the software engineering department”, the electronic processor 20 may be configured to replace this term with the terms “the SED” or just “SED”.

Similarly, the set of transformations may include a transformation that identifies compound words with multiple capital letters and shortens the compound words with an acronym or abbreviation based on the capital letters (a PascalCase transformation). For example, when the received text is “The name for the module is TransformGeneratorModule.”, the electronic processor 20 may apply the PascalCase transformation to replace the term “TransformGeneratorModule” with the term “TGM”. The electronic processor 20 may use a look-up table, rules, or a database to find and replace terms with appropriate acronyms or abbreviations.

The available transformations may also include a transformation that eliminates terms adding minor semantic value to text, such as articles (a drop-term transformation). For example, when the received text is “The dog and the cat ran around the yard.”, the electronic processor 20 applies the drop-term transformation to eliminate the article “the” from the text. The electronic processor 20 may use a look-up table, rules, a database, or the like to find and delete terms providing insignificant semantic meaning.

The available transformations may also include a transformation that replaces terms, such as individual words, with shorter versions or symbols (a find-and-replace transformation). For example, when the received text is “January and February are cold months.”, the electronic processor 20 may apply the find-and-replace transformation to replace “January” and “February” with “Jan” and “Feb”, respectively, and replace the term “and” with an ampersand (“&”). As further examples, the electronic processor 20 may apply the find-and-replace transformation to replace “appointment” with “apt”, replace “apartment” with “apt”, replace “without” with “w/o”, and the like. The electronic processor 20 may use a look-up table, rules, a database, or the like to recognize shorter versions and symbols for terms.

The available transformations may also include a transformation that replaces names with nicknames (a nickname transformation). For example, when the received text is “Christopher does not have an appointment.”, the electronic processor may apply the nickname transformation to replace “Christopher” with “Chris”. The electronic processor 20 may use a look-up table, rules, a database, or the like to find and replace names with nicknames.

The available transformations may also include a transformation that replaces terms with abbreviations or shorthand versions (abbreviation transformation). In some embodiments, abbreviations include abbreviations commonly used in short message service (SMS) communications. For example, when the received text is “A straight road is before you.”, the electronic processor 20 may apply the abbreviation transformation to replace the terms “straight”, “before”, and “you” with “str8”, “b4”, and “u”, respectively. The electronic processor 20 may use a look-up table, rules, a database, or the like to identify terms with commonly-recognized abbreviations or shorthand versions.

The available transformations may also include a transformation that replaces terms with emoticons (an emoticon transformation). For example, when the received text is “Being outside makes me happy.”, the electronic processor 20 may apply the emoticon transformation to replace the term “happy” with a smiley face emoticon (“ [symbol] ”). In some embodiments, the electronic processor 20 may also replace multiple terms with one or more emoticons. For example, when the received text is “the man is happy”, the electronic processor 20 may replace the entire text with an emoticon representing “man” (“♂”), an emoticon representing “is” or a relationship (“→”), and an emoticon representing “happy” (“ [symbol] ”). Thus, in this example, the text “the man is happy” is replaced with the emoticon string “♂→ [symbol] ”. The electronic processor 20 may use a look-up table, rules, a database, or the like to identify and replace terms with emoticons.

The available transformations may also include a transformation that identifies a list and replaces the elements included in the list with shortened versions (a list-reduction transformation). For example, when the received text is “Get eggs, milk, butter, and cheese from the store.”, the electronic processor 20 may apply the list-reduction transformation to replace the list “eggs, milk, butter, and cheese” with the shortened list “e, m, b, c”. Alternatively or in addition, the electronic processor 20 may shorten the list by replacing all but a predetermined number of elements with the term “etc.”, “et al.”, or the like. For example, using the above example text, the electronic processor 20 may replace the list “eggs, milk, butter, and cheese” with the list “eggs, milk, etc.” Similarly, in some embodiments, the electronic processor 20 may shorten the list by replacing the list or a portion thereof with a generic term. For example, using the above example, the electronic processor 20 may replace the list “eggs, milk, butter, and cheese” with “groceries” or “food”. The electronic processor 20 may use a look-up table, rules, a database, or the like to identify and shorten lists. For example, the electronic processor 20 may identify lists by looking for punctuation (commas, semicolons, and the like), a conjunction (“and”, “or”, or “nor”), or the like.

The available transformations may also include a transformation that removes extra spaces (a space transformation). For example, when received text includes the sentences “The cat was happy. The dog was also happy.”, the electronic processor 20 may be configured to replace the double spaces between the sentences with one space or zero spaces. Similarly, in some embodiments, the electronic processor 20 may apply the space transformation when another transformation removes or replaces terms in the original text. For example, when the original text is “The dog and the cat lived in the house.” and the electronic processor 20 removes the term “the” from the text, the alternate version of the text generated by this removal may include an extra space (the space before or after the removed term). Accordingly, the electronic processor 20 may be configured to identify multiple spaces in text and remove spaces to reduce the number of spaces to one or zero.

Accordingly, using one or more transformations, such as those described above, the length of text can be reduced in various ways. In particular, each transformation modifies received text when one or more terms included in the text satisfy a condition associated with the transformation. For example, the contraction transformation replaces multiple words with a contraction when the terms of the text include words with an available contraction. Similarly, the nickname transformation replaces a proper noun with a nickname when the terms of the text include a proper noun. Accordingly, the transformations provide various types of modifications when various conditions are satisfied.

Also, the ability to configure both the set of transformations applied and the order in which to apply the transformations allows text reduction to be customized for particular users, particular text, and the like. For example, when text is being displayed during a formal business meeting, transforming full names to nicknames or replacing terms with emoticons may not be well perceived by the audience or may cause confusion. Similarly, replacing a list of terms with just a single letter representation may be used as a last resort to shorten text rather than truncation since the letter representations may not be fully understood by an audience. For example, when long text needs to fit in a small space, more drastic transformations may be acceptable as compared to reducing text by a couple of characters. In some embodiments, a user may also configure individual transformations, such as by eliminating particular contractions, abbreviations, nicknames, and the like to further customize length reductions. Thus, the configurable transformations can adapt to user needs and preferences. In fact, in some embodiments, the electronic processor 20 (or a separate application or device) may be configured to use machine learning to learn what types of transformations should be used for particular users, particular types of text, particular reductions, and the like. In particular, the electronic processor 20 may track length reductions made by a user (or removed by a user after being applied by the electronic processor 20) to learn user preferences.

As illustrated in FIG. 3, after the set of transformations is selected (at block 33), the electronic processor 20 serially applies (in the order defined by the set of transformations) each transformation included in the set to the each of the plurality of terms satisfying a condition of each transformation to generate an alternate version of the text having an alternate length (at block 34). The electronic processor 20 continues this process while the alternate length is greater than the desired length (at block 35). However, in response to the alternate length being equal to or less than the desired length (at block 35), the electronic processor 20 outputs the latest alternate version of the text (at block 37), which as described above may be displayed within a user interface by the user device 14. Alternatively, as illustrated in FIG. 3, in response to the alternate length being greater than the desired length (at block 35) and each transformation included in the selected set of transformations having been applied (at block 38), the electronic processor 20 outputs a truncated version of the text with the desired length (at block 39). In some embodiments, the truncated version of the text includes the original text truncated to the desired length. In other embodiments, when an alternate version of the text was generated based on one or more transformations, the truncated version of the text output by the electronic processor includes the latest alternate version of the text truncated to the desired length.

Accordingly, as illustrated in FIG. 3, the electronic processor 20 serially applies a first transformation, a second transformation, a third transformation, and so on until either the desired length is achieved or all of the transformations have been applied. For example, depending on the received text, the electronic processor 20 may apply each transformation to zero or more terms depending on whether any terms included in the text satisfy the condition associated with a transformation.

In some embodiments, the electronic processor 20 applies a transformation depth-first within the hierarchy defined by the plurality of terms. Accordingly, in this configuration, the electronic processor 20 may initially process words, then phrases, then sentences, and then paragraphs. Also, the electronic processor 20 may start with terms located toward the front of the received text as compared to terms located toward the end of the received text.

When outputting length-reduced text, the electronic processor 20 may output the text within the user interface and may indicate to the user that the text length has been reduced. For example, the electronic processor 20 may display the text in a predetermined color, font, style, animation, or the like or may display an icon or other marker that informs the user that the text length has been reduced. The electronic processor 20 may also provide a selection mechanism (within the user interface) that allows a user to view the original text (which the electronic processor 20 preserves in memory during the length reduction process). The electronic processor 20 may display the original text in place of the length-reduced text or in addition to the length-reduced text, such as within a pop-up window. Thus, based on input received through the user interface, the electronic processor 20 may be view both and optionally toggle between the original text and the length-reduced text as needed. However, as the length of the text was reduced while preserving context and meaning as described above with respect to FIG. 3, the user may still be able to quickly read and understand the text from the displayed version of the text.

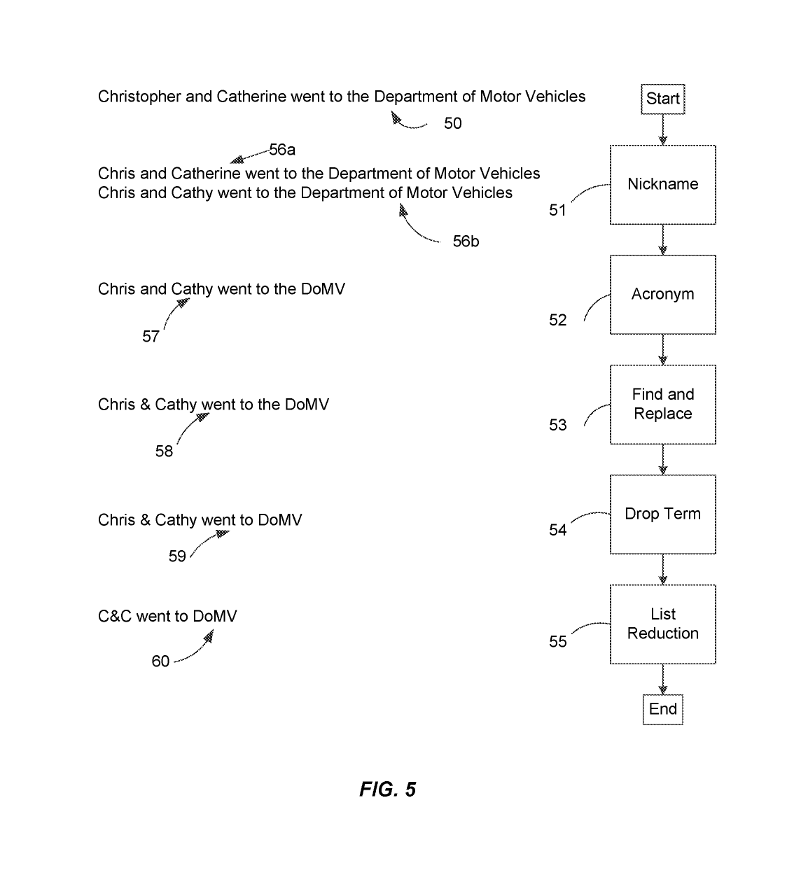

FIG. 5 illustrates one example of applying transformations as described above with respect to FIG. 3. In this example, the original text 50 is “Christopher and Catherine went to the Department of Motor Vehicles.”, which has an original length of sixty-seven characters, and the desired length is twenty characters. Also in this example, the selected set of transformations includes (in order) a nickname transformation 51, an acronym transformation 52, a find-and-replace transformation 53, a drop-term transformation 54, and a list-reduction transformation 55 as described above.

As illustrated in FIG. 5, the nickname transformation 51 is applied to the original text 50 as a first transformation. The electronic processor 20, using the nickname transformation, reduces the original text 50 to an alternate version of the text 56a “Chris and Catherine went to the Department of Motor Vehicles.” and an alternate version of the text 56b “Chris and Cathy went to the Department of Motor Vehicles.” Accordingly, in this example, the nickname transformation 51 is applied twice because two terms included in the original text 50 satisfy the condition associated with the nickname transformation 51 (two terms represent names with available nicknames).

The alternate text 56a reduces the length of the original text to sixty-one characters, and the alternate text 56b reduces the length of the original text to fifty-seven characters. As both of these lengths are greater than the desired length, the electronic processor 20 moves to the next transformation. It should be understood that the electronic processor 20 may be configured to compare an alternate length of received text to the desired length each time an alternate version of the text is generated (after each modification of the original text). However, in other embodiments, the electronic processor 20 may be configured to compare an alternate length of the text after the electronic processor 20 completes application of a transformation.

In some embodiments, the electronic processor 20 stores each alternate text (such as alternate text 56a and 56b) in a memory, such as a memory 22. Storing alternate texts generated during the reduction process allows the electronic processor 20 (or another device accessing the stored alternate text) to use stored alternate text when a desired length for particular text changes. For example, when a user modifies a size of a cell or field but does not modify the text included in the cell or field, the electronic processor 20 may access a stored alternate version of the text rather than performing the reduction method described above starting from the original text. In particular, when the desired length increases, the electronic processor 20 may access stored alternate text having the greatest length equal to or less than the increased desired length. Similarly, when the desired length decreases, the electronic processor 20 may access stored alternate text having the smallest length and using this length as the starting text for the reduction process.

Returning to FIG. 5, after the first transformation is applied, the electronic processor 20 applies the acronym transformation 52 as a second transformation. As illustrated in FIG. 5, this transformation generates alternate text 57 “Chris and Cathy went to the DoMV.” The length of alternate text 57 is thirty-three characters. As the length of alternate text 57 is greater than the desired length, the electronic processor 20 applies the find-and-replace transformation as a third transformation.

As illustrated in FIG. 5, the find-and-replace transformation generates alternate text 58 “Chris & Cathy went to the DoMV.” The length of alternate text 58 is thirty-one characters. As the length of alternate text 58 is greater than the desired length, the electronic processor 20 applies the drop-term transformation as the fourth transformation. The drop-term transformation generates alternate text 59 “Chris & Cathy went to DoMV.” The length of alternate text 59 is twenty-seven characters, which is greater than the desired length. Thus, the electronic processor 20 applies the list-reduction transformation as the fifth transformation to generate alternate text 60 “C&C went to DoMV.” (by recognizing that “Chris & Cathy” is a list). The length of alternate text 60 is seventeen characters. Accordingly, this length is less than the desired length (twenty characters), and the electronic processor 20 outputs the alternate text 60 for display within a user interface.

Thus, embodiments described herein provide methods and systems for reducing text length, such as text displayed within a space-constrained area of a user interface, without sacrificing context or meaning. As noted above, the length reduction functionality described herein may be performed locally by a user computer, remotely by a server, or a combination thereof. Also, as described above, length-reduced text may be output through a user interface displayed through a display device, a touchscreen, a virtual reality headset, or similar electronic device and the length-reduction functionality described herein may be applied before or after text is initially displayed. For example, in some embodiments, the user interface displaying the text may include a selection mechanism (such as a button or a menu option) that allows a user to turn on and off length reduction. Furthermore, it should be understood that the length-reduction functionality described herein may be used to reduce the length of text to be output through a printer, communicated over a communication network, or the like. Furthermore, the length reduction functionality described herein may be used to convert data to a different format or type, to compress data, or to perform other activities with data constraints or size requirements.

Various features and advantages of some embodiments are set forth in the following claims.

1. A system for reducing a length of text, the system comprising:
an electronic processor configured to receive text having an original length,
receive a desired length for the text,
automatically divide the text into a plurality of terms by generating a hierarchy of terms based on the text,
automatically select from a plurality of available transformation types a set of transformation types for the text based on at least one rule, the at least one rule being associated with at least one selected from a group consisting of an identifier of a user, the text, the hierarchy of terms, the original length, the desired length, and a software application outputting the text,
automatically, serially apply each transformation type included in the set of transformation types to each of the plurality of terms included in the hierarchy of terms satisfying a condition associated with each transformation type to generate an alternate version of the text having an alternate length less than the original length while the alternate length is greater than the desired length,
in response to the alternate length being equal to or less than the desired length, output the alternate version of the text having the alternate length being equal to or less than the desired length for display within a user interface, and
in response to the alternate length being greater than the desired length after application of each of the transformation type included in the set of transformation types, output a version of the text truncated to the desired length for display within the user interface.

2. The system of claim 1, wherein the electronic processor is configured to generate the hierarchy of terms based on the text using a grammar parser.

3. The system of claim 1, wherein the electronic processor is configured to serially apply each transformation type included in the set of transformation types to the plurality of terms depth-first based on the hierarchy of terms.

4. The system of claim 1, wherein the electronic processor is further configured to automatically select an order of the set of transformation types, the order defining an order of application of the set of transformation types.

5. The system of claim 4, wherein the order of the set of transformation types is from least aggressive to more aggressive.

6. The system of claim 4, wherein the electronic processor is configured to automatically select the order of the set of transformation types based on at least one selected from a group consisting of the identifier of the user, the text, the hierarchy of terms, the original length, the desired length, or the software application outputting the text.

7. The system of claim 1, wherein the electronic processor is configured to output the version of the text truncated to the desired length by outputting the text as received truncated to the desired length.

8. The system of claim 1, wherein the electronic processor is configured to output the version of the text truncated to the desired length by outputting the alternate version of the text having a shortest length truncated to the desired length.

9. The system of claim 1, wherein the desired length is specified in a number of characters.

10. The system of claim 1, wherein the desired length is specified in a length measurement.

11. The system of claim 1, wherein the electronic processor is further configured to output at least a portion of the text as received in response to user input associated with the alternate version of the text output for display within the user interface.

12. The system of claim 1, wherein the electronic processor is further configured to
store each alternate version of the text in a memory,
receive an updated desired length of the text,
retrieve an alternate version of the text stored in the memory based on the updated desired length, and
output an alternate version of the text having the updated desired length based on the alternate version of the text retrieved from the memory.

13. The system of claim 12, wherein the electronic processor is configured to output the alternate version of the text having the updated desired length based on the alternate version of the text retrieved from the memory by outputting the alternate version of the text retrieved from the memory when the updated desired length is greater than the desired length.

14. The system of claim 12, wherein the electronic processor is configured to output the alternate version of the text having the updated desired length based on the alternate version of the text retrieved from the memory by applying at least one transformation included in the set of transformations to each of the plurality of terms satisfying a condition associated with the at least one transformation included in the alternate version of the text retrieved from the memory when the updated desired length is less than the desired length.

15. A method for reducing a length of text, the method comprising:
receiving, with an electronic processor, text having an original length;
receiving, with the electronic processor, a desired length for the text;
automatically, with the electronic processor, dividing the text into a plurality of terms by generating a hierarchy of terms based on the text using at least one grammar parser;
automatically, with the electronic processor, selecting from a plurality of available transformation types a set of transformation types for the text based on at least one rule, the at least one rule being associated with at least one selected from a group consisting of an identifier of a user, the text, the hierarchy of terms, the original length, the desired length, and a software application outputting the text;
automatically, with the electronic processor, serially applying each transformation type included in the set of transformation types to each of the plurality of terms included in the hierarchy of terms satisfying a condition associated with each transformation type to generate an alternate version of the text having an alternate length less than the original length while the alternate length is greater than the desired length;
in response to the alternate length being equal to or less than the desired length, outputting, with the electronic processor, the alternate version of the text having the alternate length being equal to or less than the desired length for display within a user interface; and
in response to the alternate length being greater than the desired length after application of each of the transformation types included in the set of transformation types, outputting, with the electronic processor, a version of the text truncated to the desired length for display within the user interface.

16. The method of claim 15, wherein receiving the desired length includes automatically determining the desired length based on the user interface.

17. The method of claim 15, wherein automatically, serially applying each transformation type included in the set of transformation types to the plurality of terms includes applying each transformation type included in the set of transformation types to the plurality of terms depth-first.

18. The method of claim 15, further comprising automatically selecting an order of the set of transformation types, the order defining an order of application of the set of transformation types and the order being from least aggressive to more aggressive.

19. A non-transitory computer-readable medium including instructions executable by an electronic processor to perform a set of functions, the set of functions comprising:
receiving text having an original length;
receiving a desired length for the text;
automatically dividing the text into a plurality of terms;
automatically selecting from a plurality of available transformation types a set of transformation types and an order of the set of transformation types for the text based on at least one rule, the at least one rule being associated with at least one selected from a group consisting of an identifier of a user, the text, the original length, the desired length, and a software application outputting the text;
automatically serially applying each transformation type included in the set of transformation types to each of the plurality of terms satisfying a condition associated with each transformation type to generate an alternate version of the text having an alternate length less than the original length while the alternate length is greater than the desired length;
in response to the alternate length being equal to or less than the desired length, outputting the alternate version of the text having the alternate length being equal to or less than the desired length for display within a user interface; and
in response to the alternate length being greater than the desired length after application of each of the transformation types included in the set of transformation types, outputting a version of the text truncated to the desired length for display within the user interface.

20. The non-transitory computer-readable medium of claim 19, wherein the set of functions further comprises:
storing each alternate version of the text in a memory;
receiving an updated desired length of the text;
retrieving an alternate version of the text stored in the memory based on the updated desired length; and
outputting an alternate version of the text having the updated desired length based on the alternate version of the text retrieved from the memory.
